(19) United States
(12) Patent Application Publication
(10) Pub. No.: US 2015/0339569 A1
(43) Pub. Date: Nov. 26, 2015

(54) SECURITY MARKER SYSTEMS AND METHODS WITH VALIDATION PROTOCOL

(71) Applicant: SmartWater Ltd, Liverpool (GB)

(72) Inventor: Michael Cleary, Liverpool (GB)

(73) Assignee: SMARTWATER LTD, Liverpool (GB)

(21) Appl. No.: 14/720,725

(22) Filed: May 22, 2015

Related U.S. Application Data
(60) Provisional application No. 62/001,854, filed on May 22, 2014.

(51) Int. Cl. G06K 19/18; G06K 1/12; G06K 9/00

(52) U.S. Cl. CPC G06K 19/18; G06K 9/00006; G06K 1/12

(57) ABSTRACT

The present disclosure relates to systems and methods which utilize a security marker featuring redundancy. In particular, the security marker may include a forensic marker component having a specific combination of predetermined characteristics that directly corresponds to data provided in a database and a validation marker component having a specific combination of separate and distinct predetermined characteristics that are independent of the forensic marker component and which also correspond to the same data provided in the database as the forensic marker component. Thus, the validation marker component may advantageously provide independent means for validating results obtained using the forensic marker component. In this way, the redundancy provided by the second validation marker component may improve the accuracy/reliability of the marker and/or the resiliency of the marker (for example, in the case of degradation of the forensic marker component).

### CROSS-REFERENCE TO RELATED APPLICATIONS

The subject application claims priority to U.S. Provisional Application No. 62/001,854, entitled “Improvements in the Validation of Marker Systems,” filed May 22, 2014, the contents of which are hereby incorporated herein. The present application also relates to U.S. application Ser. No. 14/714,168, entitled “Security Marker,” filed May 15, 2015, the contents of which are hereby incorporated herein.

### TECHNICAL FIELD

The present disclosure relates to security measures and in particular, security measures which may be used in the identification/authentication of goods so as to be able to, for example, distinguish original goods from counterfeit goods and/or to identify stolen goods or articles.

### BACKGROUND

There is an ever increasing level of crime in terms of the theft of valuable items. Goods not previously thought to be valuable are now also subjected to theft. In addition, profits from the production of counterfeit goods continues to rise. This is an international crime that has grown over recent years such that it is estimated to account for 6% of world trade and is increasing rapidly.

Marker systems have been used extensively for many decades and have been based upon many different types of methods and systems, including for example, chemical or DNA fingerprints. The use of a marker system in a court of law does require a guaranteed level of utility. Clearly, the reliability of any given marker system may be demonstrated through repeated successful outcomes within a criminal justice system. A system incorporating multiple independent markers, the analysis of which would provide increased verification of an authenticity of the marker.

Various measures have also been put into place to help distinguish between a genuine product and a counterfeit copy. Complex labeling is used in the form of branding and logo's as the first line of defense. However, the funds available to counterfeiters are such that they can use the highest quality printing methods to duplicate the branding themselves, so that the logo's and labels become counterfeit. In order to combat this, complex features that are difficult to copy have been added by manufacturers to make any copying more difficult. Such features include bar-coding, reflective and refractive inks and holograms.

However, these measures have also been copied and accordingly manufacturers have adopted the approach of adding markers to their products as a further way of deterring the production of counterfeits. Several different types exist that are both overt and covert. Overt markers are visible under normal lighting and can be designed in many different ways that are difficult to reproduce exactly. Others are covert and require some form of stimulation before they can be seen. These can also contain various features that are difficult to reproduce such as for example a random pattern.

A further type of marker system which may be used contains a covert fingerprint within the marker. One of the first such systems involved the use of DNA fingerprints containing artificially produced base sequences which provided a unique identification of the item to which it was applied. However, one weakness of DNA lies in its relative fragility and so this may be degraded through sunlight, heat or alkaline conditions. The reliability and efficacy of such systems is based upon their ability to correctly convey information when required. This is dependant to some extent upon the methods of sampling and the training given to those involved. However it is also based upon the stability of the marker system in use and its resistance to deterioration through aging and or weathering.

Some markers, for example DNA markers are susceptible to degradation in external conditions due to heat, UV or high intensity visible radiation, humidity and pH. For example, The damage to a DNA molecule used as a security marker caused by exposure to aggressive radiation, heat, humidity, pH or chemicals will result in a failure to identify any fingerprint upon analysis. This could result in genuine items being classed as counterfeit and the legal ramifications and costs to both sides in the legal disputes that will follow will be enormous. Others such as those based upon chemical or metallic fingerprints are normally more stable and reliable. If a marker degrades it means that it will not convey the necessary information which can undermine the system in use and more importantly may convey an inaccurate result.

There is therefore, a definite need in any marker system to be used, and in particular in marker systems that are used to provide evidence in a Court of Law, for the incorporation of a totally separate and reliable validation mechanism in such products which obviates or substantially negates the possibility of any erroneous result being provided. Such a validation system, should therefore immediately indicate if an error had occurred before the erroneous result is acted upon with all the problems that that can cause.

Some validation methods exist, as disclosed in GB2413675B, but these lack the flexibility required to cover a system that provides large numbers of unique products. For example, in GB2413675 there is described a means of validating the result of any marker system used. However, the validation system in use in this disclosure merely provides a generalized indication of the number of characteristics or facets that are present in the marker system. It does not provide a system that directly correlates with the information provided in the database and which the marker also corresponds to.

Thus, there exists a need for new and improved security marker systems and methods and, in particular, those that provide resilient and reliable identification of marked items. These and other needs are met by the systems and methods disclosed herein.

### SUMMARY

The present disclosure relates to advantageously systems and methods which utilize a security marker featuring redundancy. In particular, the security marker may include a forensic marker component having a specific combination of predetermined characteristics that directly corresponds to data provided in a database and a validation marker component having a specific combination of separate and distinct predetermined characteristics that are independent of the forensic marker component and which also correspond to the same data provided in the database as the forensic marker component. Thus, the validation marker component may advantageously provide independent means for validating results obtained using the forensic marker component. In this way, the redundancy provided by the second validation marker component may improve the accuracy/reliability of the marker and/or the resiliency of the marker (for example, in the case of degradation of the forensic marker component).

In example embodiments, the redundancy featuring security marker may feature additional levels of redundancy. For example, in some embodiments, the marker may include a second level of redundancy by way of a second validation marker component having a specific combination of separate and distinct predetermined characteristics that are independent of both the forensic marker component and the first validation marker component. The second validation marker component may therefore also provide independent means for validating results obtained using the forensic marker component.

In some instances, a forensic marker component may suffer degradation after it is applied to a item, e.g., either due to natural wear and tear or due to more nefarious efforts. In such instances, the forensic marker component may sometimes still provide some identification information but may not provide sufficient information to make a positive identification of the correlating data. For example, an analysis of a degraded forensic marker component may identify several possible matches each having a same probability or a different probability of being a correct correlation. Similarly, in some instances the validation marker component may also suffer degradation, e.g., wherein the validation marker component may also provide some identification information but not of a sufficient caliber to make a positive identification of the correlating data. Thus, in example embodiments, a combined analysis of the forensic marker component and the validation marker component may provide information that would not otherwise be obtainable via independent analysis of the marker components.

For example, in some embodiments, a set of possible correlation data matches may be determined for both the forensic marker component and the validation marker component (or for each of the validation marker components if there are a plurality of validation marker components). An overlap between the two sets of possible correlation data matches may then be used determine a correct data correlation or at the very least to eliminate some of the possible matches from consideration. In some embodiments, a combined probability for each of the possible matches may be determined by multiplying the negative probabilities for a possible the match together for each of the components (i.e. for the forensic component and each validation component) and then subtracting that from 100% to obtain the combined positive match probability. For example, in the case that a first possible match has a 70% positive probability with respect to the forensic marker component and 80% positive probability with respect to the validation component, the combined positive probability may be calculated as: 100%−(20%*30%)=94% combined positive probability. Alternatively, an average probability may utilized for the combined analysis.

In example embodiments the forensic marker component and the validation marker component (even sans degradation thereof) may each correlate to a number of different possible data correlations (i.e. the signature provided by the combined characteristics thereof may have a one-to-many relationship with respect to data correlation). In such embodiments, a combined analysis of the forensic marker component and the validation marker component may be used to determine a correct correlation or to reduce the number of possible correlations.

Alternatively, in some embodiments, an un-degraded forensic marker component may correlate to a specific data correlation (i.e. the signature provided by the combined characteristics thereof may have a one-to-one relationship with the with respect to data correlation). Even in such embodiments, the validation marker component prove useful in accounting for any error associated with the forensic marker component, e.g., due to degradation thereof. In some embodiments the validation marker component may also correlate to a specific data correlation (i.e. the signature provided by the combined characteristics thereof may have a one-to-one relationship with the with respect to data correlation). Thus, the validation component may serve as a complete and independent back-up. Alternatively, the validation component (even sans degradation thereof) may each correlate to a number of different possible data correlations (i.e. the signature provided by the combined characteristics thereof may have a one-to-many relationship with respect to data correlation). Thus, the validation component may serve to validate or improve the accuracy of an analysis of the forensic marker component. It is noted that by having a one to many relationship may reduce the overall complexity of the signature and therefore the required combination of characteristics. This may facilitate a faster analysis thereof as well as enable use of a particular forensic marker component on multiple items (provided of course that different validation marker components are applied to each).

In example embodiments, the redundancy featuring security marker may be utilized to guard against false positive identifications, e.g., where a same or different false positive probability exists for each possible data correlation. Thus, in the case that the signature of the forensic marker component is altered (e.g., by way of degradation, additive components, or other changes) or in the case of measurement error or human error, a false positive may be detected using the validation marker component. For example, in case the forensic component match has a false positive match with a higher positive probability (e.g., 90% positive probability) than a correct positive match (e.g., with an 80% positive probability), a subsequent validation may reveal the mistake and improve the accuracy. For example, the combined probability or average probability may be higher for the correct positive match (such as may result, e.g., from 10%, 80% positive probability prediction using the validation marker component for the false positive match and correct positive match, respectively, which based on the example numbers herein yields combined probabilities of 91% and 96% or average probabilities of 50% and 80% respectively, both favor of the correct positive match).

In example embodiments, a redundancy featuring security marker may, e.g., instead of including separate forensic and validating components, include a forensic signature with built in redundancy. For example, the specific combination of predetermined characteristics may include redundant characteristics that mean the same thing with respect to the signature (e.g., in the case of the signature representing a binary string, two or more characteristics may correspond to the same bit of information or to each bit of information).

In example embodiments, a validation system may advantageously be based upon the use of a simpler and on the spot analysis, compared to the system used to identify the forensic marker component. It may, for example, be based upon a physical system of data presentation rather than one involving chemical analysis and in this way overcomes the need for a second chemical analysis.

Chemical analysis can be lengthy and correspondingly expensive and requires expertise and expensive equipment. It is an absolute requirement for any primary forensic analysis of a marker, but would be unwelcome in any type of back-up system, that merely provides confirmation of the analysis, as this would just add to the running costs of the system and the expense involved in its operation.

The present disclosure provides a method of checking the validity of the reported result and highlights any problems before the result is reported and prevents any issues from developing. It is also quick, does not involve chemical analysis and is therefore also a low cost operation.

If a discrepancy occurs between the analytical result and the validation system then crucially the problem has been identified and further reporting of a possibly wrong result has been stopped. This then allows time for a complete check and overhaul of all systems involved in the analysis when hopefully the cause of the discrepancy will be found. If not then a void result is reported, but most importantly the wrong result has not been reported.

Also provided by the present disclosure is a method of manufacturing a marker system which comprises a) applying on a forensic marker component a combination of a predetermined number of characteristics and which characteristics correspond to data provided in a database and b) applying on a separate validation marker component a separate and distinct combination of predetermined characteristics which also corresponds to the data provided in the database.

### BRIEF DESCRIPTION OF THE DRAWINGS

The above and other aspects, features and advantages of the disclosure will be apparent from the following more particular description of examples, as illustrated in the accompanying drawings, in which:

FIG. 1 depicts an exemplary validation enabled security marker and related systems and methods, according to the present disclosure.

### DETAILED DESCRIPTION

A description of example embodiments of the present disclosure follows. The teachings of all patents, published applications and references cited herein are incorporated by reference in their entirety.

The present disclosure relates to the field of security and security marking and in particular a marker for tracing/identifying items or personnel coming into contact with such items.

The present disclosure relates to advantageously systems and methods which utilize a security marker featuring redundancy. In particular, the security marker may include a forensic marker component having a specific combination of predetermined characteristics that directly corresponds to data provided in a database and a validation marker component having a specific combination of separate and distinct predetermined characteristics that are independent of the forensic marker component and which also correspond to the same data provided in the database as the forensic marker component. Thus, the validation marker component may advantageously provide independent means for validating results obtained using the forensic marker component. In this way, the redundancy provided by the second validation marker component may improve the accuracy/reliability of the marker and/or the resiliency of the marker (for example, in the case of degradation of the forensic marker component).

In example embodiments, the redundancy featuring security marker may feature additional levels of redundancy. For example, in some embodiments, the marker may include a second level of redundancy by way of a second validation marker component having a specific combination of separate and distinct predetermined characteristics that are independent of both the forensic marker component and the first validation marker component. The second validation marker component may therefore also provide independent means for validating results obtained using the forensic marker component.

In some instances, a forensic marker component may suffer degradation after it is applied to a item, e.g., either due to natural wear and tear or due to more nefarious efforts. In such instances, the forensic marker component may sometimes still provide some identification information but may not provide sufficient information to make a positive identification of the correlating data. For example, an analysis of a degraded forensic marker component may identify several possible matches each having a same probability or a different probability of being a correct correlation. Similarly, in some instances the validation marker component may also suffer degradation, e.g., wherein the validation marker component may also provide some identification information but not of a sufficient caliber to make a positive identification of the correlating data. Thus, in example embodiments, a combined analysis of the forensic marker component and the validation marker component may provide information that would not otherwise be obtainable via independent analysis of the marker components.

For example, in some embodiments, a set of possible correlation data matches may be determined for both the forensic marker component and the validation marker component (or for each of the validation marker components if there are a plurality of validation marker components). An overlap between the two sets of possible correlation data matches may then be used determine a correct data correlation or at the very least to eliminate some of the possible matches from consideration. In some embodiments, a combined probability for each of the possible matches may be determined by multiplying the negative probabilities for a possible the match together for each of the components (i.e. for the forensic component and each validation component) and then subtracting that from 100% to obtain the combined positive match probability. For example, in the case that a first possible match has a 70% positive probability with respect to the forensic marker component and 80% positive probability with respect to the validation component, the combined positive probability may be calculated as: 100%−(20%*30%)=94% combined positive probability. Alternatively, an average probability may utilized for the combined analysis.

In example embodiments the forensic marker component and the validation marker component (even sans degradation thereof) may each correlate to a number of different possible data correlations (i.e. the signature provided by the combined characteristics thereof may have a one-to-many relationship with respect to data correlation). In such embodiments, a combined analysis of the forensic marker component and the validation marker component may be used to determine a correct correlation or to reduce the number of possible correlations.

Alternatively, in some embodiments, an un-degraded forensic marker component may correlate to a specific data correlation (i.e. the signature provided by the combined characteristics thereof may have a one-to-one relationship with the with respect to data correlation). Even in such embodiments, the validation marker component prove useful in accounting for any error associated with the forensic marker component, e.g., due to degradation thereof. In some embodiments the validation marker component may also correlate to a specific data correlation (i.e. the signature provided by the combined characteristics thereof may have a one-to-one relationship with the with respect to data correlation). Thus, the validation component may serve as a complete and independent back-up. Alternatively, the validation component (even sans degradation thereof) may each correlate to a number of different possible data correlations (i.e. the signature provided by the combined characteristics thereof may have a one-to-many relationship with respect to data correlation). Thus, the validation component may serve to validate or improve the accuracy of an analysis of the forensic marker component. It is noted that by having a one to many relationship may reduce the overall complexity of the signature and therefore the required combination of characteristics. This may facilitate a faster analysis thereof as well as enable use of a particular forensic marker component on multiple items (provided of course that different validation marker components are applied to each).

In example embodiments, the redundancy featuring security marker may be utilized to guard against false positive identifications, e.g., where a same or different false positive probability exists for each possible data correlation. Thus, in the case that the signature of the forensic marker component is altered (e.g., by way of degradation, additive components, or other changes) or in the case of measurement error or human error, a false positive may be detected using the validation marker component. For example, in case the forensic component match has a false positive match with a higher positive probability (e.g., 90% positive probability) than a correct positive match (e.g., with an 80% positive probability), a subsequent validation may reveal the mistake and improve the accuracy. For example, the combined probability or average probability may be higher for the correct positive match (such as may result, e.g., from 10%, 80% positive probability prediction using the validation marker component for the false positive match and correct positive match, respectively, which based on the example numbers herein yields combined probabilities of 91% and 96% or average probabilities of 50% and 80% respectively, both favor of the correct positive match).

In example embodiments, a redundancy featuring security marker may, e.g., instead of including separate forensic and validating components, include a forensic signature with built in redundancy. For example, the specific combination of predetermined characteristics may include redundant characteristics that mean the same thing with respect to the signature (e.g., in the case of the signature representing a binary string, two or more characteristics may correspond to the same bit of information or to each bit of information).

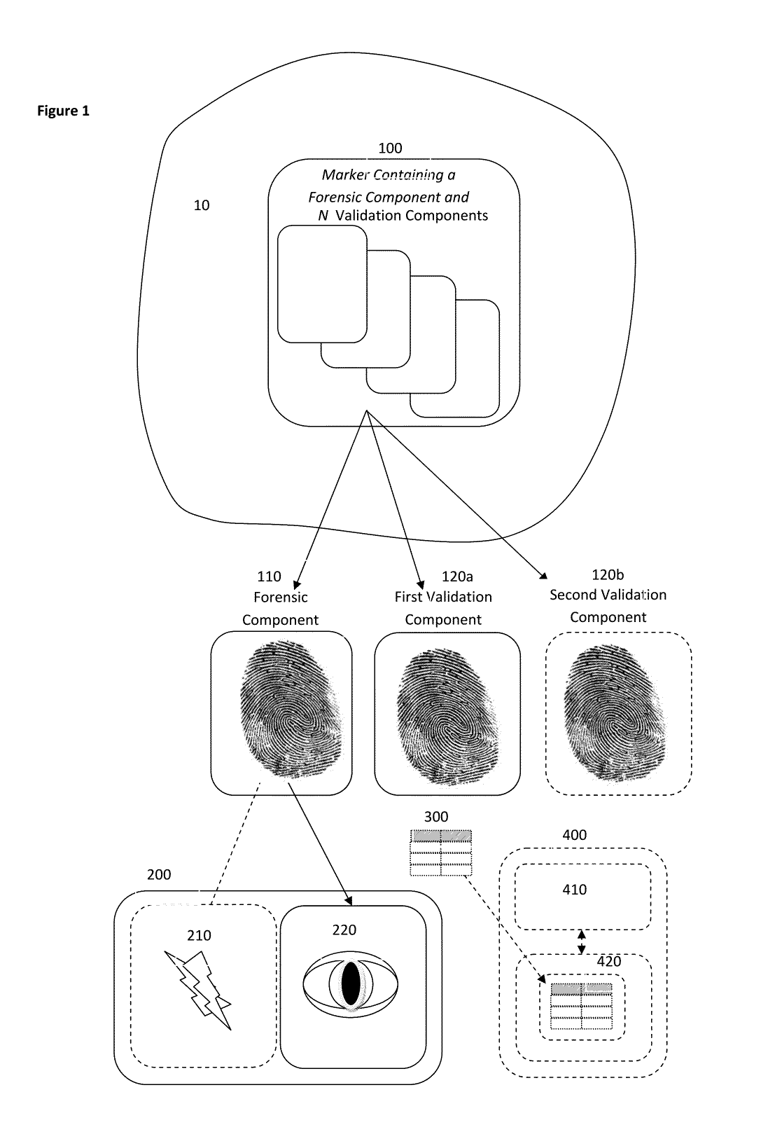

With reference to FIG. 1, an exemplary redundancy/validation enabled security marker 100 is depicted. Security marker 100 may advantageously be associated with an protected item 10, such as a consumer product requiring identification/authentication. In general, the security marker 100 may include a forensic component 110 and N validation components 120a and 120b, each characterizing a unique signature (i.e. a signature based on a combination of distinct characteristics) correlating to the same data. The N components may represent the batch information for the marker and may be known/recorded at the time of creation of the marker 100.

In example embodiments, a security system may be provided which includes, both a security marker 100, such as described herein, and an analysis tool 200 configured for enabling analysis the marker, e.g., for analysis of the forensic marker component 110 and the validation marker components 120a, 120b. In further example embodiments, the security system may also include correlation information 300 (e.g., for correlating each of the unique signatures to the same data.

In some embodiments, the analysis tool 200 may include a stimulation mechanism 210 for stimulating the marker such as to cause the cause the marker to exhibit an observable property/characteristic. In example embodiments, the observable property/characteristic may be hidden/less observable prior to the stimulation. Example properties/characteristics may include photo-responsive properties/characteristics (e.g., florescence, directionally specific reluctance patterns, etc.) thermo-response properties/characteristics (e.g., thermochromic), electro-responsive proprieties/characteristics, mechanically-responsive properties/characteristics or other types of properties/characteristics responsive to different types of stimuli. In further example embodiments, the analysis tool 200 may include an examination mechanism 220 for examining the marker for qualifying or quantifying a signature of the forensic marker component 110 and/or the validation marker component(s) 120a and 120b, e.g., based on the stimulus. Thus, the examination mechanism may be configured for observing, qualifying and/or quantifying property/characteristics of the marker.

With reference still to FIG. 1, in some embodiments the correlation information 300 may operatively be associated with the analysis tool 200, e.g., so as to enable automatic correlation of a detected signature to the underlying data. Thus, in some embodiments, the correlation information 300 and analysis tool 200 may be operatively associated with processing system 400 including a processor 410 configured, e.g., via association with non-transient processor executable instructions, to enable the automatic identification of the underlying data correlating to the detected signature of the forensic marker component 110, and for validating such correlation using a validation marker component 120a or 120b. In such embodiments the processor may further be associated with non-transient memory 420 adapted for storing (i) the processor executable instructions, (ii) the correlation information 300 and/or (iii) data received from the analysis tool 200, e.g., relating to, a signature of the forensic marker component or the validation component. In other embodiments, the correlation information 300 may be provided as a reference to enable a user to correlate a detected signature to the underlying data.

In example embodiments, the present disclosure may involves the use of a validation marker component, such as a particle that contains a visible code, that is linked to the forensic code obtained through analysis of the main marker system. The system may use any type of validation marker component such as a particle, which may be colour coded, the use of different single polymer bases, different combined polymer bases, a variation of the ratio of each of the polymers present in any blend of polymers used, or a polymer powder which is of a different chemical entity and which is added in places to the main polymer base. Therefore, any system may be used which has the potential to be sufficiently flexible to validate the potentially very large range of forensic marker components that may be utilized. In the present description a validation particle is described but it should be understood to those of skill in the art that any number of different validation marker components may be used.

This use of a validation particle in the validation system has the flexibility to cope with the full range of mixtures that can be produced by most marker systems. Some such systems can produce an infinite number of codes, although in practice one billion unique codes could be taken as infinite. A particle can be marked with a nine digit numerical code can be varied so as to provide 1 billion unique numerical codes. Such a system could be based upon a 3×3 array of the numbers 0-9. However this can be quite easily increased, a 4×4 array would allow ten thousand trillion codes to be produced, to all practical purposes and infinite number.

It can be seen that the disclosed system has the scale to be utilized with any marker system, whatever the range of fingerprints available.

The particle upon which this validation system is based can be tailored to suit the needs of the marker system also in terms of how it is presented to the marker system. Marker systems can be water or solvent based and particles can be produced on media suitable to either. Water based marker systems can be very aggressive to some forms of printed media that could be used in the production of digits on particles.

Paper is not a suitable substrate as it does not have the necessary strength when in a thin cross-section as found in printed sheet. Neither does it have the stability required for use in water based systems, which will degrade its structure.

Normal print on plastic media is sufficient in non-aqueous systems, but susceptible to lifting off the printed surface when in storage in aqueous media. This means that the digits are no longer on the particle when it is applied or that they are rubbed off the particle when it is brushed onto the surface to which the mark is applied. Shelf life prior to use of the marker is critical in this situation and is beyond the control of those supplying the validation or marker system. Generally a one year shelf life is acceptable, but this is beyond what is possible for most print on a plastic substrate.

The present disclosure can be presented to suit the media in which the marker system is produced. Clearly cost is an important issue and for non-aqueous systems a simple photographic image on photographic film will be completely suitable for any length of time in storage prior to use.

Aqueous systems are more of a problem as above and such systems can be based upon two liquid phases when in storage such that the particles spend most of their time in a heavier organic layer in which they are stable.

A further suitable approach for aqueous media involves 3D printing of the digits using a suitably coloured material onto a suitably coloured substrate. The digits formed through the use of preferably a suitable plastic can be seen through a contrast between these and the substrate, preferably plastic, which can be acrylate based in both cases.

They may also be metallic or ceramic based. These latter two particles are impervious to most typical media systems. The metal on which the particle is based can be chosen from several that are known to be resistant to most forms of aqueous media, nickel is a good example.

The stability of the validation system once applied and dried to a surface coating is no longer an issue in terms of its stability in the medium in which it is stored.

The printing of digits on both ceramic and metallic substrates can be performed through laser etching which is a permanent mark and is also resistant to aqueous media.

A further aspect of the present disclosure is the size of the particle on which the code is printed. This can be changed to suit the requirements of the marker system in use. The digit size can be altered to suit whatever size of particle is required for the marker system in use. Clearly an issue relates to the reading of particularly small digits.

One of the key features of the present disclosure is that it is easy and quick to use and this argues against a small particle with correspondingly smaller digits. These will require greater magnification and this does tend to involve more rigorous measurement requirements. Conversely a lot of work is done with covert markers that are designed not to be easily seen and given this, a large particle is not really suitable.

The optimum size of the particle will be dependent on each marker system used, but the present disclosure can be used with any size of particle. Laser marking or photographic images can be made to virtually any size. 3D printing can be used in most cases, but may have difficulty if very small digits are required.

The forensic marker component preferably comprises an indicator material, which can quickly provide a preliminary, gross indication of the presence of a marker system according to the present disclosure. The indicator material can either be “overt” or “covert.” An overt material is typically one which can be seen unaided by technology, such as a dye or pigment. With an overt indicator, it is immediately evident from an observation of the article or person that a mark has been provide thereon which may act as a deterrent. In one embodiment both a covert and overt mark may be applied thus combining the deterrent effect of the overt mark with the covert properties of the covert mark. For example, if the overt mark failed to act as a deterrent and the perpetrator tried to remove the overt mark; even if they were successful the stolen item could nevertheless still be identified by virtue of the covert mark.

A covert indicator will remain hidden until some technical means or stimulus is used to make it obvious. Usually, a covert indicator will become visible upon application of a radiation source other than visible light, and of these, fluorescent indicators are most common. Thus, the covert indicator will often be at least one fluorescent material which is soluble in a solvent system, and which is easily detectable upon examination with ultraviolet light, for example. Alternatively or additionally, the indicator may comprise at least one phosphorescent material capable of phosphorescing when subjected to stimulus.

In terms of suitable indicators, both organic and inorganic materials were tested. Some organics, especially of the oxazinone functionality performed well, but did still degrade well below the required temperature and lost their fluorescence.

A preferred compound for use in the present disclosure as an indicator is an inorganic emitter.

The product can be water or solvent based and can contain a dissolved or dispersed polymer solution or dispersion. Both are designed to allow transferability while the product is wet and then to form a clear, discrete surface coating when dry. The marker system preferably includes a matrix and an aqueous polymer emulsion to bind a marker to the surfaces of items, articles, goods, vehicles and/or premises. Advantageously, the polymer system, which may be water based to avoid the use of solvents, initially acts as an adhesive to secure the marker or surface coating to the goods being protected. As the goods may be subject to high temperatures, it may be desirable for the matrix to be able to withstand high temperatures; failing which, the matrix may lose its adhesion to the surface, by for example carbonising, and the marker system will simply fall off the surface, when the marker system is subjected, either directly or indirectly, to high temperatures. In order to ensure that a stolen item is identifiable even where it has been subjected to heat; it is desirable for the polymer emulsion and matrix combination to secure the marker system across a wide range of temperatures.

Various fingerprint technologies can be used singly or in combination with the preferred product containing at least two such technologies. The chemical and metallic fingerprints are based upon mixtures of components used only once and not repeated.

The fingerprint may comprise a solvent medium containing a volatile component, together with for example one or more trace materials which can be varied in such a manner as to produce unique formulations. The combinations of trace materials may advantageously be varied by modeling the compositions on, for example, binary strings to produce large numbers of unique products. However, other suitable coding methodologies may also be utilised as appropriate. The term “trace materials” applies herein to materials which would not normally be present in the environment of use. The most commonly used trace materials are metal compounds.

Trace materials can advantageously therefore be combined in a way which gives good evidential value to law enforcement agencies, as each unique formulation may be allocated to a particular premises, location or person, and this information is stored in a central database which can be accessed by a law enforcement agency receiving the report of a laboratory analyzing the mixtures which are to be discussed.

The trace materials may be assigned constant positions in a binary string with their presence being given by a “1”, and their absence by a “0”. If, for example, one were to set a limit of thirty digits for the string, one could begin with combinations of two trace materials, and generate all combinations containing any two trace materials. One could then go to groups of three trace materials, and generate all combinations of any three trace materials. This could continue until the number of trace materials is equal to the number of digits in the string.

With a thirty digit string, the total number of unique combinations of trace materials is approximately one billion. However, it is possible to prepare an infinite number of mixtures having compositions based upon unique binary sequences, the composition of each being unique.

Binary strings are provided as exemplary of the manufacturing procedures which can be used. Octal strings may also be used. Decimal numbers and random number generation can be used to generate potential codes, although these will need to be checked and converted to binary or octal sequences prior to use.

The unique nature of each composition can be checked during Quality Control following manufacture. The composition can then be stored in a database, allocated to a premises, location, or person, and the source of goods located at a later time can be traced to the premises, location or person via the composition.

Of course, the greater the number of trace materials used, the greater the certainty in identification later on, since the chance presence of trace materials can be ruled out.

In one embodiment of the present disclosure, inorganic materials may be used as the fingerprint. These materials have the best performance, of the materials tested.

A preferred fingerprint for use in the present disclosure is an organometallic material.

Advantageously, when the fingerprint allotted to any given item or location is recorded in the database, a separate numerical code is also then applied to a particle which may then be included in the solution and which acts as the validation particle, the validation code thus also corresponding to the item or location stored in the database and associated with the fingerprint.

### ILLUSTRATIVE EXAMPLE

For the purposes of this example one method by which the current disclosure could be used is described.

A photographic image based upon particles cut from photographic film will be used as an example. In this case a spreadsheet is produced containing preferably 500 cells. Each cell is constructed so that it contains preferably a 3 by 3 matrix of digits. The digits are the same in each cell and the same in each cell of the spreadsheet. The digits are obtained from a database which is used to produce suitable unique numerical codes. Each spreadsheet as described uses a different unique number from the database.

Each spreadsheet, which is preferably A4 in size is photographed and the image transferred to microfilm. Each frame of the microfilm is then cut with a laser so that each cell is a different diced section of plastic containing the 3×3 array of digits forming the required code. These can then be added to a marker system based upon a suitable solvent which is preferably isopropyl alcohol.

The validation code may be chosen to be the same code as the fingerprint code, in which case the same mathematical method that generates the code for the fingerprint may be used to print the code onto the validation particle. In this embodiment the data from the forensic code generator is sent to an automated production line that controls the addition of various fingerprint materials dependent upon the code in question. That same code is then used as the basis of generating the spreadsheets discussed above. Each numerical code is used to populate 500 cells of a spread sheet and this is then cut and diced by a laser to form a batch of particles. At one point in the production line, the particles are added to the batch of product having the same fingerprint code as shown on the particle.

It is also possible to use a totally different code on the validation particle to the code for the validation fingerprint. In this case a separate step is required to ensure that the two are recorded together and that one will always be accepted as the validation code for the other. There is an extra strength to this approach in that the validation code on the particle does not reveal the numerical forensic code for the marker. Knowledge of the numerical code without the knowledge to convert this to a chemical code is of limited use, but if that link is entirely arbitrary, then even this is removed.

Such a system can then be applied by brush or spray depending upon the chosen size of the particle to the substrate to be marked.

While the present disclosure has been particularly shown and described with references to example embodiments thereof, it will be understood by those skilled in the art that various changes in form and details may be made therein without departing from the scope of the present disclosure encompassed by the appended claims.

1. A marker system for identifying/tracing items comprising
i) a forensic marker component having a specific combination of predetermined characteristics that directly corresponds to certain data provided in a database
ii) a validation marker component having separate and distinct predetermined characteristics that are independent of the forensic marker component and which also directly correspond to the same data provided in the database as the forensic marker component,
wherein the identification of the validation marker component provides a means of independently validating the result obtained from the forensic marker component.

2. A marker system according to claim 1, wherein said forensic marker component comprises a unique fingerprint which is any of DNA, a chemical fingerprint, a metal based fingerprint.

3. A marker system according to claim 1 wherein said validation marker component comprises a coded particle.

4. A marker system according to claim 1 wherein the particle is any of plastic, metallic or ceramic and includes a visible code thereon.

5. A marker system according to claim 1 further comprising an indicator of the presence of the marker system.

6. A marker system according to claim 1, wherein the code used to generate the validation marker component is the same as the forensic marker component.

7. A marker system according to claim 1, wherein the code used to generate the validation marker component is different to that used to generate the forensic marker component.

8. A method of manufacturing a marker system according to claim 1 and which method comprises a) applying in a forensic marker component a combination of a predetermined number of characteristics and which characteristics directly correspond to data provided in a database and b) applying on a separate validation marker component a separate and distinct combination of predetermined characteristics which also directly corresponds to the data provided in the database.

9. A method according to claim 8, wherein said forensic marker component comprises a unique fingerprint which is any of DNA, a chemical fingerprint, or a metal based fingerprint.

10. A method according to claim 8 wherein said validation marker component comprises a coded particle.

11. A method according to claim 8 wherein the particle is any of plastic, metallic or ceramic and includes a visible code thereon.

12. A marker system according to claim 8 further comprising an indicator of the presence of the marker system.

13. A marker system according to claim 8, wherein the code used to generate the validation marker component is the same as the forensic marker component.

14. A marker system according to claim 8, wherein the code used to generate the validation marker component is different to that used to generate the forensic marker component.
